(19) United States
(12) Patent Application Publication
(10) Pub. No.: US 2015/0201778 A1
(43) Pub. Date: Jul. 23, 2015

(54) ROLL-UP SPOON REST

(71) Applicant: Robinson Home Products Inc., Williamsville, NY (US)

(72) Inventors: Stuart Harvey Lee, Forest Hills, NY (US); Inbal Zahava Aderka, Brooklyn, NY (US)

(73) Assignee: Robinson Home Products Inc., Williamsville, NY (US)

(21) Appl. No.: 14/157,706

(22) Filed: Jan. 17, 2014

(51) Int. Cl. A47G 21/04; F16M 13/02

(52) U.S. Cl. CPC A47G 21/04; F16M 13/022

(57) ABSTRACT

A spoon rest formed of a flexible body and a retainer, the flexible body having a terminal end, a fixed end, a top surface and a bottom surface and the a retainer having a concave receiver, where the flexible body can be adapted from an open, substantially flat configuration to a rolled up, stored configuration where the rolled up flexible body is retained substantially within the concave receiver of the retainer.

### FIELD OF THE INVENTION

The present invention relates to household items and, more particularly, to a spoon rest for resting a spoon or other utensil with food residue on it between repeated uses.

### BACKGROUND OF THE INVENTION

A spoon rest is a common item in a kitchen, which serves as a place to lay a spoons and other cooking utensil, such as a ladle, stirrer, etc., to prevent cooking fluids from getting onto countertops, as well as keeping the spoon from touching any contaminants that might be on the counter. Such a spoon rest may be used, for example, while making a sauce, where the cook periodically stirs the sauce with a single spoon and requires a place to rest the spoon between stirrings without having to clean the spoon or the counter.

Although the cook can use other kitchen items like a dish or bowl to rest a spoon during repeated uses without cleaning, those items can be unnecessarily large, taking up too much counter space, and requiring additional effort for cleaning. Spoon rests have therefore become widely used for the specific purpose of resting a spoon during repeated use without cleaning.

Despite taking up less space on a countertop during use, current spoon rests take up a fair amount of space during storage. Therefore, a spoon rest that could be stored in a smaller space would advance the art.

Additionally, spoon rests are traditionally made from ceramic, porcelain, stainless steel, stone or similar materials used for cooking. As such, spoon rests have generally not taken advantage of newer materials being introduced into kitchen use.

Although, as set out above, many different types of kitchen tools and/or utensils can be placed on a spoon rest between repeated uses during cooking, all such tools and/or utensils will be referred to as a spoon for the purpose of this specification.

### SUMMARY OF THE INVENTION

The present invention is directed to a spoon rest comprising a flexible body portion and a retainer portion, the flexible body portion having a terminal end, a fixed end, a top surface and a bottom surface and the a retainer portion having a concave receiver, wherein the flexible body portion is adaptable from an open, substantially flat configuration to a rolled up, stored configuration, in which the rolled up flexible body portion is retained substantially within the concave receiver of the retainer portion. This permits the spoon rest of the present invention to be placed flat on a planar surface, such as a countertop, when in use and rolled up into a smaller volume for storage.

In its preferred embodiment, the retainer portion further comprises a first catch element that cooperates with a corresponding catch element on the bottom surface of the flexible body portion. The first catch element and corresponding catch element can be any cooperating elements that permit the rolled up flexible body portion to be retained in the concave receiver during storage, including snaps, clips, clasps, friction surfaces, magnets or the like. However, in its most preferred embodiment the first catch element is a detent in the area of the upper opening of the concave receiver and the corresponding catch element comprises a series of recesses, which can take the form of cut-outs or carve-outs in the bottom surface, gaps in material, spaces within dimples, the area between ridges, openings in the flexible body portion and/or combinations of these, hereinafter individually and collectively referred to as recesses, on the bottom surface of the flexible body portion.

In this preferred embodiment, the series of recesses are in the area of the detent when at least a portion of the rolled up flexible body portion is inserted into the concave receiver, with the detent on the concave receiver, preferably in the form of an elongated detent, engaging one of the series of recesses. The series of recesses are used as the cooperating catch element to provide some tolerance in the event that the flexible body portion is not rolled up in a consistent diameter, and are most preferably a series of parallel grooves on the bottom surface of the flexible body portion in about the area where the bottom surface of the flexible body portion aligns with the first catch element within the upper edge of the concave receiver.

The top surface of the flexible body portion preferably comprises a bounded area near the terminal end. The bounded area can be in the form of a depression, a raised wall or a combination of these in which the head of a spoon that has been in contact with food may be set, so that the bounded area retains spillage of food remnants from the spoon head. Additionally, the retainer portion preferably includes an upper surface having a capture element, such as a central indentation or spaced-apart detents, to maintain the handle of the spoon within the bounds of the upper surface of the retainer portion.

Although the flexible body portion and retainer portion can be made of any suitable materials, it is preferred that the flexible body portion is made of a flexible food grade silicone material and the retainer portion be made of a rigid or semi-rigid plastic. Notwithstanding, it is understood that the retainer portion can also be made of a silicone material, and could be molded from a silicone of different characteristics or of the same characteristics in a thicker form, provided that the concave receiver of the retainer portion does not readily deform and allow the rolled up flexible body portion to disengage from the concave receiver unintentionally.

Moreover, the flexible body portion preferably includes an upturned end which has been found to facilitate rolling up the flexible body portion for storage. As with the receiver portion, the upturned end can be made unitary with the flexible body portion, of the same material as the flexible body portion, or can be made of a silicone material with different characteristics, a rigid (including a semi-rigid) plastic material, or any other suitable material.

### BRIEF DESCRIPTION OF THE DRAWINGS

The attached drawings, in which like reference characters indicate like parts, are intended to better illustrate a preferred embodiment of the present invention without limiting the invention in any manner whatsoever.

FIG. 1 is a side elevation of a spoon rest according to the teachings of the present invention in its open, flat configuration.

FIG. 2 is a top plan view of the spoon rest of FIG. 1 in its open, flat configuration.

FIG. 3 is a bottom plan view of the spoon rest of FIG. 1 in its open, flat configuration.

FIG. 4 is a side elevation of the spoon rest of FIG. 1 in its closed, rolled up configuration.

FIG. 5 is an end elevation of the retainer portion of the spoon rest of FIG. 1.

### DETAILED DESCRIPTION OF THE PREFERRED EMBODIMENT

The following description of the preferred embodiment is presented to describe the subject invention without limiting the scope of the appended claims in any manner whatsoever.

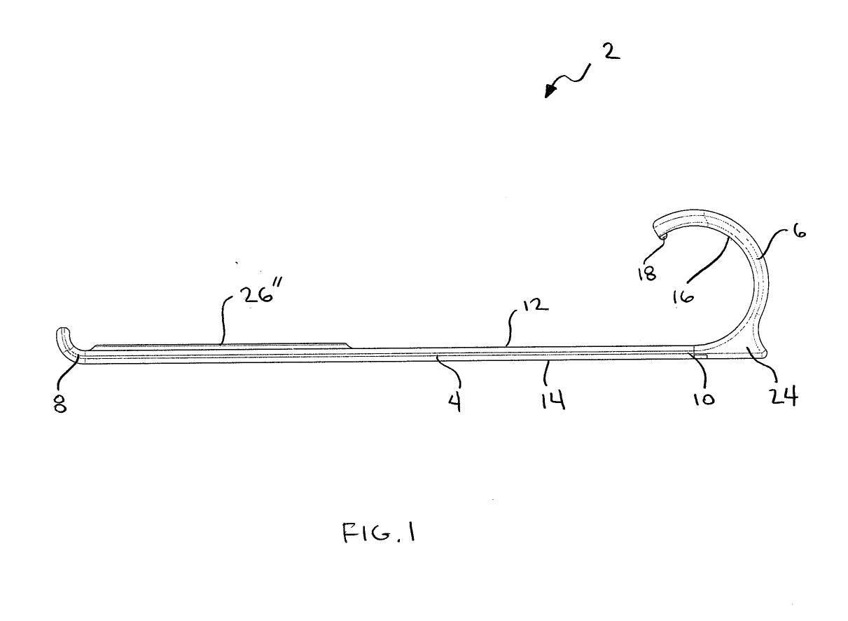

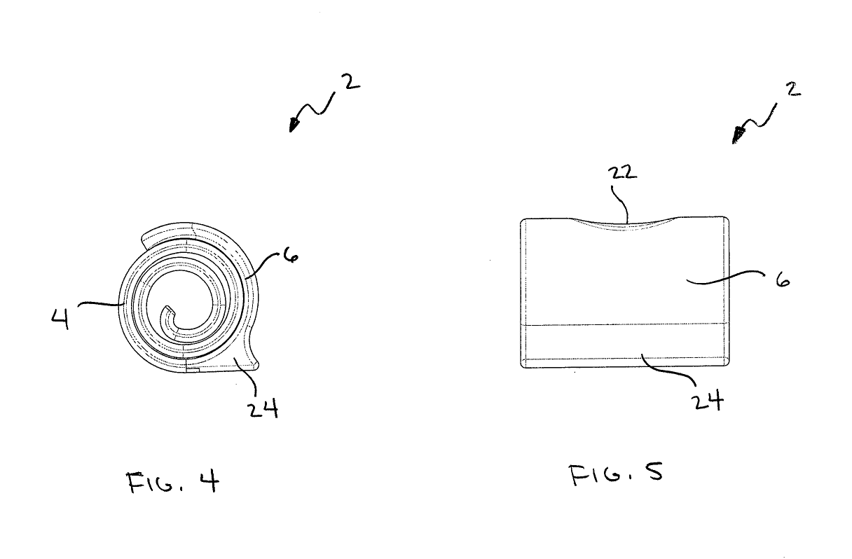

As shown in the Figures, and particularly FIGS. 1 and 4, the present invention is directed to a spoon rest 2 comprising a flexible body portion 4, said flexible body portion 4 having a terminal end 8, a fixed end 10, a top surface 12 and a bottom surface 14, and a retainer portion 6 coupled to the fixed end 10 of the flexible body portion 4, said retainer portion 6 comprising a concave receiver 16.

The flexible body portion 4 is adaptable from an open, substantially flat configuration (shown in FIGS. 1-3), where the bottom surface 14 of the flexible body portion 4 may rest on a planar surface such as a countertop, to a rolled up, stored configuration (shown in FIG. 4), where the rolled up flexible body portion 4 is retained substantially within the concave receiver 16 of the retainer portion 6. Of course, the bottom surface 14 may have grooves, ridges or other patterns along the entire length and still be considered substantially flat.

The retainer portion 6 is preferably formed in a semicircular “C” shape that is preferably greater than 180°, with an opening that is greater than 60° but less than 180° for receiving and retaining the rolled up flexible body portion 4 when in the stored configuration. The retainer portion 6 also preferably includes a first catch element 18 comprising a detent in the form of a raised bar forming an elongated detent just inside the upper opening of the concave receiver 16. The catch element 18 preferably cooperates with a corresponding catch element 20 on the bottom surface of the flexible body portion 4, described below, to keep the flexible body portion 4 within the concave receiver 16 when in the stored configuration.

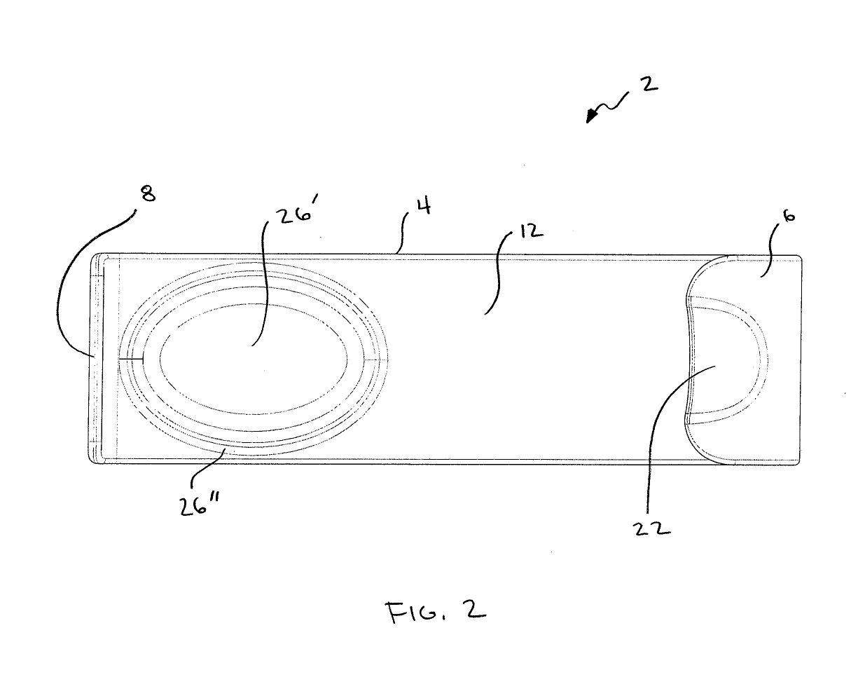

The retainer portion 6 also preferably comprises a capture element 22 on an upper surface to maintain the handle of a spoon resting on the spoon rest 2 within the bounds of the upper surface of the retainer portion 6. The capture element 22 is shown in FIGS. 2 and 5 as a central indentation, however, it can comprise spaced-apart protrusions (not shown) or the like that are similarly capable of maintaining the spoon handle within the bounds of the upper surface of the retainer portion 6.

In its most preferred embodiment, the retainer portion 6 also includes a foot 24 to provide stability for the spoon rest 2 to stand when in the rolled up, stored configuration. It is understood that a foot 24 is preferably formed as an extension of the base of the retainer portion 6 opposite the fixed end 10 of the flexible body portion 4, the base of the foot being generally in the plane formed by the bottom surface 14 of the flexible body portion 4 when in the open configuration.

The flexible body portion 4 preferably comprises a bounded area 26 on the top surface 12 near the terminal end 8. The bounded area 26 can be in the form of a depression 26′, a raised wall 26″, a combination of these, as shown in FIG. 2, or other equivalent structure to retain spillage from the spoon head in the area where the head of a spoon may be set.

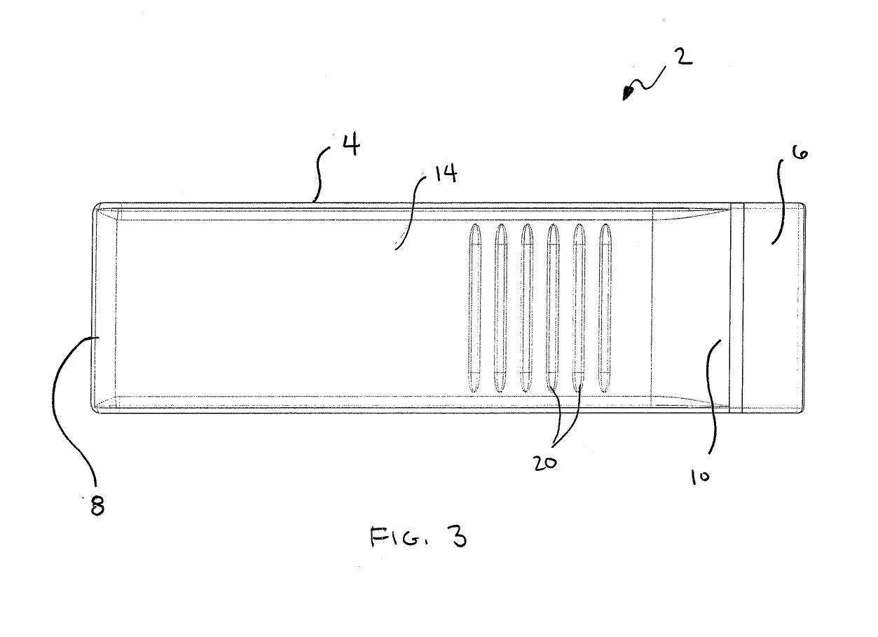

The bottom surface 14 of the flexible body portion 4 also preferably includes a corresponding catch element 20 for cooperating with the first catch element 18 of the retainer portion 6, described above. Once again, the corresponding catch element 20 can be any element that cooperates with the first catch element 18, and is shown in FIG. 3 as a series of recesses in the form of grooves or indentations, that can be engaged by the detent comprising the first catch element 18 shown in FIG. 1. The series of recesses are preferably used instead of a single recess so that the first catch element 18 need not precisely align with one groove or indentation, allowing for tolerance in the diameter of the rolled up flexible body portion 4.

The terminal end 8 of the flexible body portion 4 shown in the drawings is preferably upturned, extending above the plane of the top surface 12 of the flexible body portion 4, and shown in FIG. 1 as a semicircular end. Such an upturned end, whether in a semicircular, circular or other shape, has been found to facilitate the rolling up of the flexible body portion 4.

The component parts of the spoon rest 2 can be made of any one or more materials suitable for their intended purpose. However, the contemplated preferred embodiment uses a food grade silicone material for the flexible body portion 4, and preferably a silicone based thermoplastic rubber (TPR) having a type A shore durometer of from about 55 to about 75, with about 65 being most preferred. Depending on the material, the thickness of the flexible body portion 4, from the top surface 12 to the bottom surface 14, can be predetermined to provide sufficient integrity as well as the required flexibility. The contemplated thickness when using the preferred food grade silicone is from about 1/16 to about ¼ of an inch, with about ⅛ of an inch being preferred.

The retainer portion 6 can be made of the same or different material as the flexible body portion 6, either with the same or different characteristics, depending on the material and the design of the spoon rest. Notwithstanding, it is understood that the retainer portion 6 be of sufficient structural integrity, based on such things as the size of the opening of the concave receiver 16, that it will retain the rolled up flexible body portion in the concave receiver 16 to avoid unintentional release of the flexible body portion 4. In keeping, the most preferred embodiment includes the retainer portion 6 formed out of a plastic material that is rigid, which is herein defined as including semi-rigid, such as a polypropylene, to hold its shape more consistently.

The spoon rest 2 can be any appropriate length and width for holding a spoon used in cooking. Generally, a width of about 2½ to about 5 inches is preferred with about 2½ to about 3½ inches being more preferred. Also, it is preferred that the width is substantially uniform over the length of the spoon rest 2, however, it is understood that the width can vary over the length of the spoon rest 2.

The length of the spoon rest 2 is generally sufficient to permit the spoon head to rest in the bounded area 26 with the spoon handle on the capture element 22. To accommodate a variety of spoons, it has been found that the overall length of the spoon rest 2 may be from about 8 to about 12 inches, with from about 10 to about 11 inches being preferred, permitting an overhang of the concave retainer 16 of about 1 to about 2 inches. The distance from the front edge of the capture element 22 at the upper surface of the retainer portion 6 to the bounded area 26 should be sufficient to permit the balance point of a larger than typical spoon at rest on the spoon rest 2 to be located between the front edge of the capture element 22 and the bounded area 26. This keeps the spoon from tipping to the handle side when the retainer portion 6 acts as a fulcrum under the spoon handle.

Moreover, the height of the retainer portion 6 is determined to not only properly receive and retain the rolled up flexible body portion 4, but also to provide a suitable angle for the spoon between the bounded area 26 and the capture element 22 without any features on the handle resting on the supporting surface. Additionally, as will be apparent to one skilled in the art, the concave receiver 16 is sized to accept the rolled up flexible body portion 4, the size of the concave receiver 16 determined based on the length and thickness of the flexible body portion 4.

One skilled in the art will also appreciate that the spoon rest 2 of the present invention can be made by any suitable means, but that injection molding is most preferred. In the preferred embodiment using a rigid plastic retainer portion 6 and a silicone flexible body portion 4, the rigid retainer portion 6 may be molded first and the remaining flexible body portion 4 is molded to the retainer portion 6.

Variations, modifications and alterations to the above detailed description will be apparent to those skilled in the art. All such variations, modifications and/or alternatives are intended to fall within the scope of the present invention, limited only by the appended claims. All cited patents and publications are hereby incorporated by reference.

We claim:

1. A spoon rest comprising a flexible body portion and a retainer portion, the flexible body portion having a terminal end, a fixed end, a top surface and a bottom surface and the a retainer portion having a concave receiver, wherein the flexible body portion is adaptable from an open, substantially flat configuration to a rolled up, stored configuration in which the rolled up flexible body portion is retained substantially within the concave receiver of the retainer portion.

2. The spoon rest of claim 1 wherein the retainer portion further comprises a first catch element and the flexible body portion further comprises a corresponding catch element, wherein the first catch element and corresponding catch element cooperate to maintain the rolled up flexible body portion substantially within the concave receiver of the retainer portion when in its stored configuration.

3. The spoon rest of claim 2 wherein the first catch element comprises a detent within the concave receiver and the corresponding catch element comprises one or more recesses on the bottom surface of the flexible body portion.

4. The spoon rest of claim 1 wherein the flexible body portion further comprises a bounded area on the top surface.

5. The spoon rest of claim 4 wherein the bounded area is taken from the group consisting of a depression, one or more walls and a combination thereof.

6. The spoon rest of claim 1 wherein the retainer portion is formed in a semicircular “C” shape that is greater than 180°.

7. The spoon rest of claim 1 wherein the retainer portion further comprises a capture element on an upper surface of the retainer portion.

8. The spoon rest of claim 6 wherein the capture element is taken from the group consisting of an indentation, one or more protrusions and combinations thereof.

9. The spoon rest of claim 1 wherein the terminal end of the flexible body portion has an upturned end extending above the plane of the top surface of the flexible body portion.

10. The spoon rest of claim 8 wherein the upturned end is upturned in a semicircular shape.

11. The spoon rest of claim 1 wherein the flexible body portion is formed of a food grade silicone material.

12. The spoon rest of claim 1 wherein the retainer portion is formed of a rigid plastic material.

13. The spoon rest of claim 10 wherein the flexible body portion has a thickness of from about 1/16 to about ¼ inch.

14. The spoon rest of claim 1 wherein the spoon rest has a width of from about 2½ to about 5 inches.

15. The spoon rest of claim 1 wherein the spoon rest has a length of from about 8 to about 12 inches.

16. The spoon rest of claim 1 wherein the retainer portion further comprises a foot to stabilize the spoon rest when standing in the rolled up configuration.

17. The spoon rest of claim 1 wherein the foot is an extension of the retainer portion 6 opposite the fixed end 10 of the flexible body portion 4, said foot having a base substantially in the plane formed by the bottom surface of the flexible body portion 4 when in the open, flat configuration.
